(19) United States
(12) Patent Application Publication
(10) Pub. No.: US 2024/0223030 A1
(43) Pub. Date: Jul. 4, 2024

(54) MOTOR STATOR WIRING STRUCTURE AND METHOD FOR MAKING THE SAME

(71) Applicant: SAGITTA INDUSTRIAL CORPORATION, Taipei (TW)

(72) Inventor: FANG-FU CHANG, Taipei (TW)

(21) Appl. No.: 18/388,136

(22) Filed: Nov. 8, 2023

(30) Foreign Application Priority Data
Jan. 4, 2023 (TW) 112100261

(51) Int. Cl. H02K 1/18; H02K 3/28; H02K 15/00; H02K 15/02; H02K 15/12

(52) U.S. Cl. CPC H02K 1/18; H02K 3/28; H02K 15/0068; H02K 15/02; H02K 15/12; H02K 2203/09

(57) ABSTRACT

A motor stator wiring structure includes a stator wiring frame, a connecting element, and a wire group. The stator wiring frame has a block which has a connecting portion. The connecting portion has a first mating surface. Each wire in the wire group has a bare wire segment, an encapsulation segment, and an extension segment. The encapsulation segments of the wires are assembled within channels of the connecting member. The connecting member has a second mating surface that is connected to the first mating surface of the connecting portion. Multiple coils are wound around the stator wiring frame, and the lead ends of the coils are respectively wound around the bare wire ends of the wires and soldered in place. This achieves the simplification of the production process, reduction of production costs, and adaptability to adjusting the wiring for motors of different size specifications in the motor stator wiring structure.

### FIELD OF THE INVENTION

The present invention relates to a stator wiring structure and a method for making the same, particularly to a simplified wiring structure for a stator wire frame, where the output ends of the coil winding group are directly connected to the wire group to adjust the wiring for motors of different size specifications.

### BACKGROUND OF THE INVENTION

Motors are commonly found electrical devices in daily life and the structure of the motors commonly includes an external stator and a rotor axially located within the stator. Depending on the position of the magnetic field, motors can generally be categorized as inner rotor motors and outer rotor motors.

The inner rotor motors are characterized that the coils are wound around the stator wire frame, and the magnetic poles are located on the inner rotor. These motors have fewer poles, higher rotational speeds, and lower torque.

The outer rotor motors, on the other hand, have the magnetic poles set within the inner wall of the stator, while the coils are wound around the rotor. These motors have more poles, lower rotational speeds, and higher torque.

Regardless of the type of motor, once the coil winding is completed, it is necessary to connect the output ends of the coils to the external components so as to be connected to starting capacitors, control switches, or speed control circuits. A known stator coil wiring structure, such as Taiwan Patent Application No. 091124382 for “Sealed Compressor,” involves arranging a wire group (power terminals, lead-out wires, etc.) on a circuit board. The wire group is then connected to the stator wire frame. The output ends of the coil are connected to the circuit board, thus enabling the transmission of the required power and control signals for the motor. However, there are still several shortcomings in this patent that need improvement.

Motors are customized products, and different home appliances, machinery, equipment, or devices require motors of varying sizes and specifications. Therefore, motor manufacturers need to produce corresponding circuit boards for each motor specification, leading to increased production costs. Furthermore, placing the circuit board over the stator wire frame can affect coil heat dissipation and may result in electromagnetic interference due to the presence of circuits on the board. Moreover, the circuit board occupies space within the motor, preventing effective size reduction of the motor.

Another example is Taiwan Patent Application No. 106145416 for “Improved Structure of Built-in Capacitor Motor Wire Frame.” In this patent, a connector is used to connect the wire group (branch wires, power wires, etc.), and a connecting seat is set on the stator wire frame. The output ends of the coil are connected to the connecting seat through the connector, enabling the transmission of power and control signals between the coil and the wire group. However, there are still some shortcomings in this patent that need improvement.

The connector has multiple pins, and the connecting seat has multiple sockets. When combined, the pins inserted from one end of the sockets form electrical conduction. Moreover, the other end of the pins has a metal clip (e.g., a U-shaped clip) that holds several wires of the wire group separately. The metal clip is bent to secure the wires. However, due to the vibrations generated during motor operation, especially with higher torque and speed, structures such as the pins and sockets or the sockets and wires may experience slight loosening over prolonged motor vibrations. For example, there might be a slight gap between the inner surface of the socket and the outer surface of the pin, leading to phenomena like arcing and discharge. Similarly, vibrations might cause some edges of the metal clip to lift, creating a slight gap between the lifted edge and the wire, which could lead to dangerous arcing and discharge.

Additionally, as previously mentioned, motors are customized products. Consequently, the number of wires in the wire group varies, forcing motor manufacturers to outsource the production of specialized connectors and connecting seats based on different motor types. Particularly for connectors and seats designed to meet specific motor requirements, they cannot be easily replaced by generic connectors, which results in overly complex structures, higher production costs, and inability to simplify manufacturing processes.

China Patent Application No. 201210357198.X for “Terminal Connection Structure for Motors” and China Patent Application No. 201410528653.7 for “Motor Stator Assembly Structure” both involve placing a connecting seat on the stator wire frame. The pins of the connecting seat (or equivalent structures) connect the output ends of the coil, and the wire group is connected via a connector that attaches to the connecting seat. The wires of the wire group are held by the metal clips of the pins (or equivalent structures). The wires, pins, and sockets are still susceptible to developing slight gaps due to motor vibrations, resulting in the generation of dangerous arcing and discharge. Moreover, to prevent accidental detachment of the connecting seat and connector due to motor vibrations, these patents employ overly complex assembly structures, leading to increased production costs and the inability to effectively reduce the motor's size.

The present invention intends to provide a motor stator wiring structure to eliminate the shortcomings mentioned above.

### SUMMARY OF THE INVENTION

The first object of the present invention is to provide a motor stator wiring structure wherein a plurality of wires of the lead group are pre-assembled within a connecting member, and the connecting member is combined with the connection portion of the stator wire frame by using a mating means. The stator wire frame continues to wind the coils, and the output ends of each coil are wound around and welded to the bare wire ends of the respective wires.

The second object of the present invention is that the connection portion of the stator wire frame includes a first mating surface, while the connecting member includes a second mating surface. The second mating surface and the first mating surface are fixed by using the mating means, thereby securing the connecting member to the stator wire frame.

The third object of the present invention is that the encapsulation segments of the wires are placed within a mold. The mold is filled, cooled, and demolded to complete the connecting member.

The fourth object of the present invention is that the encapsulation segments of the wires are respectively placed within multiple slots of two clamps. The clamps are fixed to complete the connecting member.

The present invention relates to a motor stator winding structure and comprises a stator wire frame having a block connected to one side thereof, and the block includes a connecting portion which is perpendicular to the stator wire frame. The connecting portion has a first mating surface with a plurality of grooves wherein the first mating surface is located opposite to the stator wire frame. A connecting member includes a second mating surface which includes a plurality of channels. A plurality of protrusions protrude from the second matching surface. A wire group extends through the connecting member and includes multiple wires. Each wire has a bare wire end on one end thereof. An encapsulation segment and an extension segment extend along the bare wire end. The encapsulation segment is combined within the channel of the connecting member. The bare wire end and the extension segment extend out of the connecting member respectively. The second mating surface is fixed with the first mating surface by securely engaging the protrusions with the grooves to connect the connecting member onto the stator wire frame.

Preferably, the second mating surface is fixed with the first mating surface by at least one of high-frequency fusion welding, light-curing adhesive bonding, and anaerobic adhesive (Thread-locking fluid) bonding.

Preferably, the protrusions are dovetail protrusions, and the grooves are dovetail grooves.

Preferably, the connecting portion includes a plurality of separators extending from the top surface thereof. Each bare wire end of the wires extends outward from the connecting member in the same direction as the separators.

Preferably, the connecting member is formed by injection molding or hot pressing to combine with the wire group.

Preferably, the connecting member includes two clamps and each of the two clamps includes a plurality of slots. The wires are respectively placed in the slots. The two clamps fix and combine the wire group.

Preferably, the bare wire end has an adapter.

The present invention provides a method for assembling a first embodiment of the stator wire frame that includes a stator wire frame, a connecting member and a wire group, the method comprises the following steps:
a step S11: providing a mold, and an encapsulation segment of each of multiple wires of the wire group being placed inside the mold;
a step S12: extending a bare wire end and an extension segment of each wire outside the mold respectively;
a step S13: pouring material into the mold, cooling, and demolding to complete the connecting member;
a step S14: affixing a first mating surface of a connecting portion on the stator wire frame to a second mating surface of the connecting member;
a step S15: fixing the second mating surface onto the first mating surface by using a mating means;
a step S16: winding a plurality of wire coils around the stator wire frame;
a step S17: wrapping an output end of each of the wire coils around each of the bare wire ends, and
a step S18: welding and securing the respective output end and the bare wire end.

The present invention also provides a method for assembling a second embodiment of the stator wire frame that includes a stator wire frame, a connecting member and a wire group, the method comprises the following steps:
a step S21: providing a clamp with a plurality of slots defined through the clamp;
a step S22: placing an encapsulation segment of each of wires of the wire group into the respective slots of the clamp;
a step S23: extending a bare wire end and an extension segment of each of the wires outside the clamp respectively;
a step S24: fixing the clamp to complete the connecting member;
a step S25: affixing a first mating surface of a connecting portion on the stator wire frame to a second mating surface of the connecting member;
a step S26: fixing the second mating surface onto the first mating surface by using a mating means;
a step S27: winding a plurality of wire coils around the stator wire frame;
a step S28: wrapping an output end of each of the wire coils around each of the bare wire ends, and
a step S29: welding and securing the respective output end and the bare wire end.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the first embodiment of the motor stator wiring structure of the present invention;

FIG. 2 is an exploded view to show the first embodiment of the motor stator wiring structure of the present invention;

FIG. 3 shows the steps of the a method for making the first embodiment of the motor stator wiring structure of the present invention;

FIG. 4 shows a portion of the steps in FIG. 3;

FIG. 5 shows the steps of a method for making the second embodiment of the motor stator wiring structure of the present invention;

FIG. 6 shows a portion of the steps in FIG. 5;

FIG. 7 shows an exploded view to show the third embodiment of the motor stator wiring structure of the present invention;

FIG. 8 is a top view of the third embodiment of the motor stator wiring structure of the present invention, and

FIG. 9 shows the combination of the connecting member and the wire group of the third embodiment of the motor stator wiring structure of the present invention.

### DETAILED DESCRIPTION OF THE PREFERRED EMBODIMENT

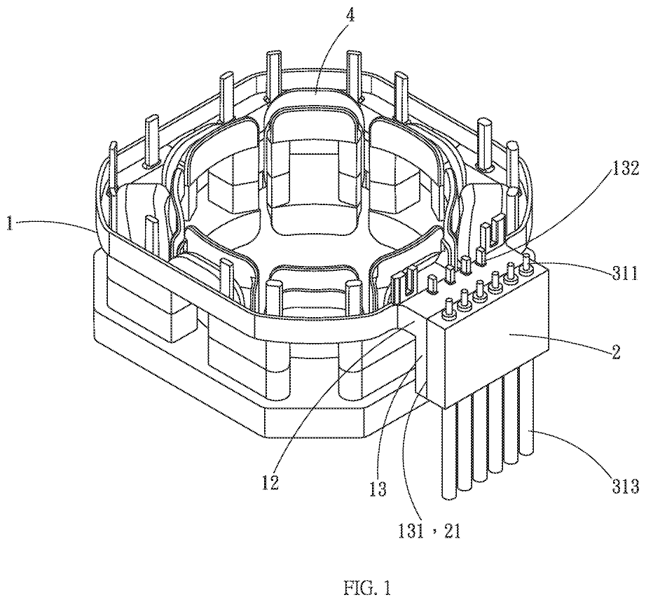

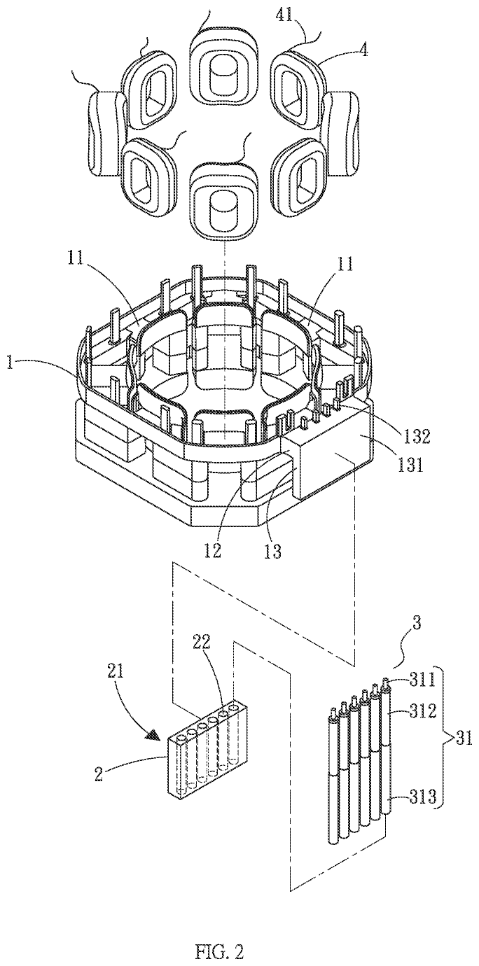

Referring to FIGS. 1 and 2, the motor stator wiring structure of the present invention comprises a stator wire frame 1, a connecting member 2, and a wire group 3. The interior of the stator wire frame 1 is hollow and has a plurality of poles 11 extending inward along the inner wall of the stator wire frame 1 for subsequent coil winding during manufacturing. One side of the stator wire frame 1 has a block 12 which has a connecting portion 13 extending therefrom. The connecting portion 13 is perpendicular to the stator wire frame 1. When the stator wire frame 1 is horizontally placed, the connecting portion 13 stands upright relative to the stator wire frame 1. The connecting portion 13 has a first mating surface 131 with a plurality of grooves 133, wherein the first mating surface 131 is located opposite to the stator wire frame 1. The connecting portion 13 includes a plurality of separators 132 extending from the top surface thereof.

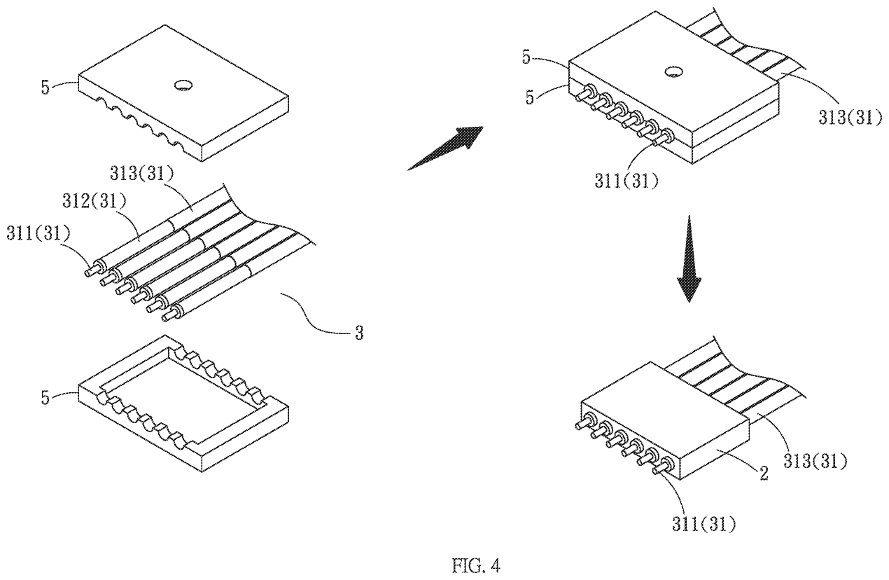

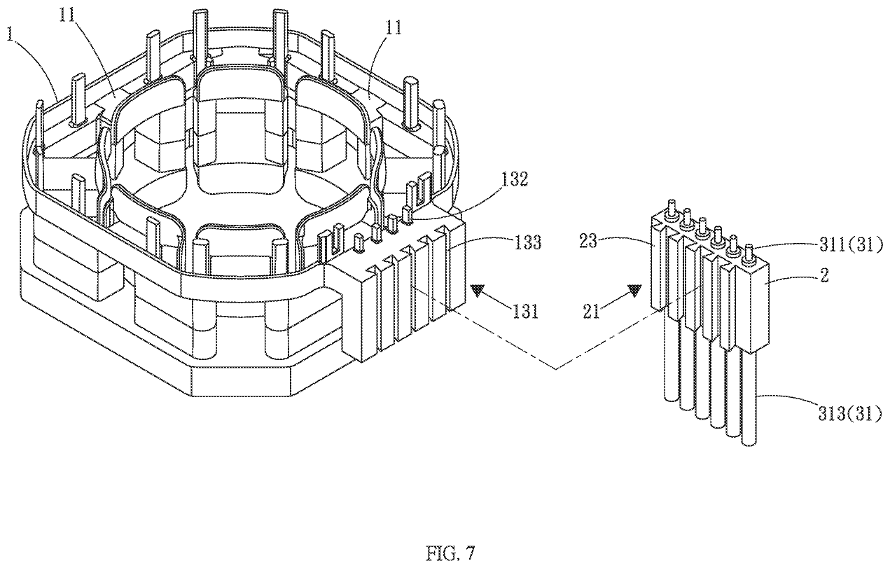

One side of the connecting member 2 is a second mating surface 21 which includes a plurality of channels 22 defined internally therethrough. It should be noted that the connecting member 2 can be produced through injection molding or hot pressing by combining molds 5 (see shown in FIG. 4), or it can be composed of two clamps 6 and each clamp 6 has multiple slots 61 as shown in FIG. 7.

Additionally, the wire group 3 comprises multiple wires 31 and each wire 31 has a bare wire end 311 at one end, followed by an encapsulation segment 312 and an extension segment 313 along the bare wire end 311. It should be noted that after the motor is assembled, each wire 31 will be electrically connected to devices as required, such as starting capacitors, power sources (direct current, unidirectional alternating current, bidirectional alternating current, or three-phase alternating current, etc.), speed controllers, torque controllers, etc., using the extension segment 313.

When the above components are combined, the encapsulation segment 312 of each wire 31 is fitted inside the connecting member 2. The bare wire ends 311 and extension segments 313 pass through the connecting member 2. The bare wire ends 311 are parallel to the direction of the separators 132 of the connecting portion 13. The second mating surface 21 of the connecting member 2 is attached to the first mating surface 131 of the connecting portion 13. The second mating surface 21 and the first mating surface 131 are fixed by using a mating means. This secures the connecting member 2 to the stator wire frame 1. The mating means include at least one of high-frequency fusion welding, light-curing adhesive bonding, or anaerobic adhesive (Thread-locking fluid) bonding, which is a non-mechanical combination technique to fix the second mating surface 21 and the first mating surface 131 together.

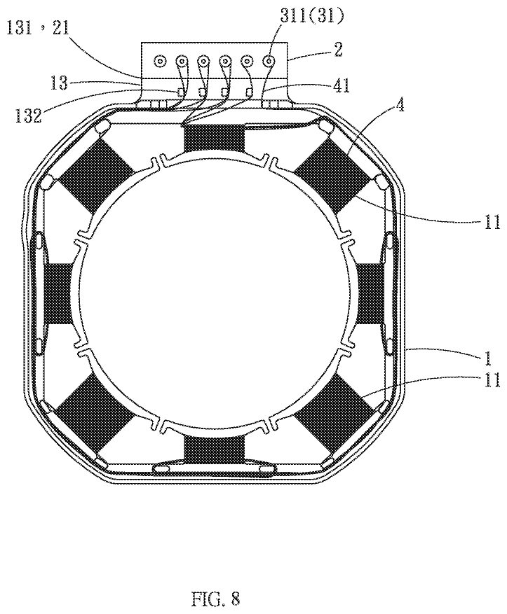

After fixing the stator wire frame 1 to the connecting member 2, coils 4 are wound around the poles 11. Each coil 4 has an output ends 41. The output ends 41 extend along the top surfaces of the block 12 and the connecting portion 13, and are wound around the bare wire ends 311 of each wire 31. The output ends 41 are fixed to the bare wire ends 311 using methods such as welding (as shown in FIG. 8). Furthermore, the separators 132 of the connecting portion 13 isolate the various output ends 41 from each other. This simplifies the wiring structure of the stator wire frame 1. The output ends 41 of the coils 4 can be directly connected to the wire group 3, achieving a simplified production process, reduced production costs, and rapid adjustment of the wiring for motors of different size specifications. Additionally, the structure of the present invention effectively prevents issues like micro gaps and loosening seen in previous technologies, thereby enhancing the motor's operational lifespan.

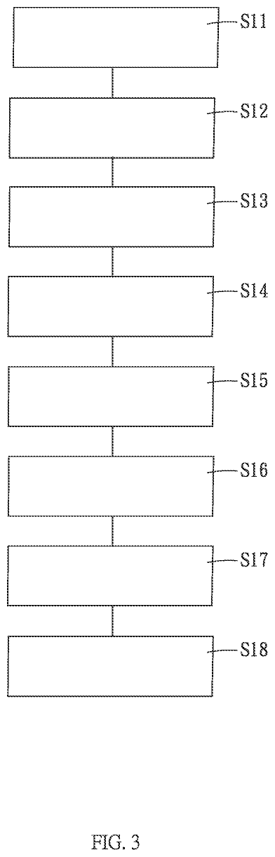

As shown in FIGS. 1 to 4, the method for assembling the first embodiment of the stator wire frame that includes a stator wire frame 1, a connecting member 2 and a wire group 3, the method comprises the following steps:
a step S11: providing a mold 5, and an encapsulation segment 312 of each of multiple wires 31 of the wire group 2 being placed inside the mold 5;
a step S12: extending a bare wire end 311 and an extension segment 313 of each wire 31 outside the mold 5 respectively;
a step S13: pouring material into the mold 5, cooling, and demolding to complete the connecting member 2;

During the above steps, place the encapsulation segments 312 of the wires 31 inside the mold 5. The interior of the mold 5 forms a pouring space 51, with the encapsulation segments 312 situated within the pouring space 51, while the bare wire ends 311 and extension segments 313 protrude and extend outside the mold 5. Inject molten plastic into the pouring space 51 of the mold 5, and after the plastic cools, remove the mold 5. The solidified plastic forms the connecting member 2, completing the combination of the connecting member 2 and the lead group 3. It should be noted that plastic molding techniques such as injection molding and compression molding are not specific features of this invention. This invention achieves a structure of integral molding of connecting member 2 and simultaneous combination with lead group 3 using plastic molding techniques. This includes casting, dip molding, slush molding, rotational molding, blow molding, extrusion, thermoforming, compression molding, vacuum forming, injection molding, welding, foaming, and other plastic molding techniques that achieve the integral molding of connecting member 2 and simultaneous combination with lead group 3, all of which fall within the scope of the present invention's patent claims.
a step S14: affixing a first mating surface 131 of a connecting portion 13 on the stator wire frame 1 to a second mating surface 21 of the connecting member 2;
a step S15: fixing the second mating surface 21 onto the first mating surface 131 by using a mating means;
a step S16: winding a plurality of wire coils 4 around the stator wire frame 1;
a step S17: wrapping an output end 41 of each of the wire coils 4 around each of the bare wire ends 311, and
a step S18: welding and securing the respective output end 41 and the bare wire end 311.

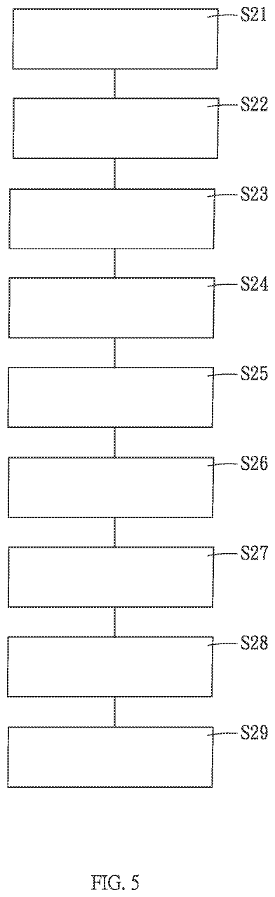

As shown in FIGS. 5 to 7, the method for assembling a second embodiment of the stator wire frame that includes a stator wire frame 1, a connecting member 2 and a wire group 3, the method comprises the following steps:
a step S21: providing a clamp 6 with a plurality of slots 61 defined through the clamp 6;
a step S22: placing an encapsulation segment 312 of each of wires 31 of the wire group 3 into the respective slots 61 of the clamp 6;
a step S23: extending a bare wire end 311 and an extension segment 313 of each of the wires 31 outside the clamp 6 respectively;
a step S24: fixing the clamp 6 to complete the connecting member 2;
a step S25: affixing a first mating surface 131 of a connecting portion 13 on the stator wire frame 1 to a second mating surface 21 of the connecting member 2;
a step S26: fixing the second mating surface 21 onto the first mating surface 131 by using a mating means;
a step S27: winding a plurality of wire coils 4 around the stator wire frame 1;
a step S28: wrapping an output end 41 of each of the wire coils 4 around each of the bare wire ends 311, and
a step S29: welding and securing the respective output end 41 and the bare wire end 311.

After the connection of the connecting member 2 with the lead group 3, the fixation of the stator wire frame 1 to the connecting member 2 proceeds, including the steps of winding and soldering, as described before.

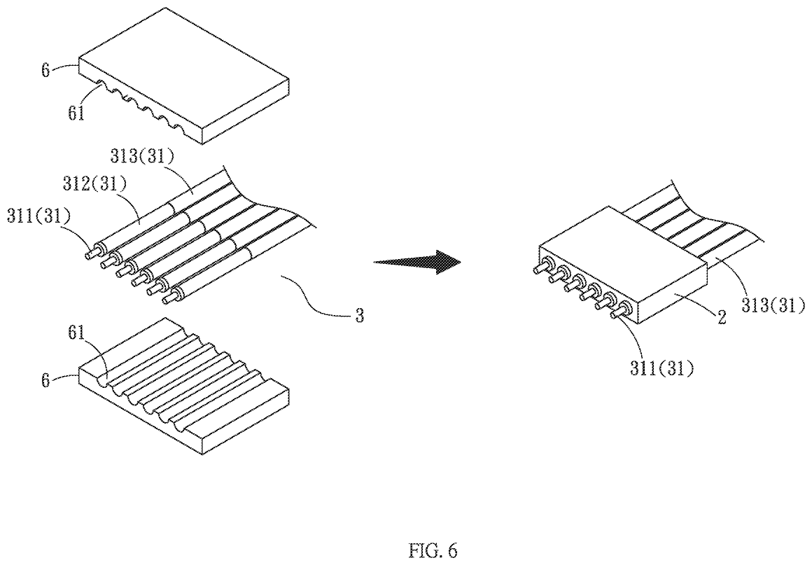

Please refer to FIG. 6, the second embodiment compared to the first embodiment is that the surface of the first mating surface 131 includes a plurality of grooves 133, and the surface of the second mating surface 21 includes a plurality of protrusions 23. Through the combination of the protrusions 23 and grooves 133, not only can the contact area between the first mating surface 131 and the second mating surface 21 be increased, but also a locating structure can be formed when the mating surface 131 is attached to the second mating surface 21, enhancing the precision during subsequent bonding procedures. As shown in FIG. 7, in the third embodiment, the protrusions 23 are dovetails, while the recesses 133 are dovetail grooves.

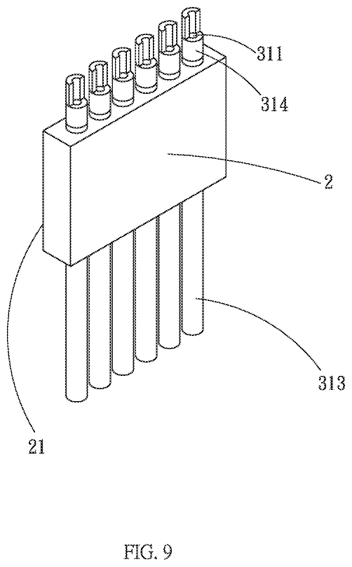

Please refer to FIGS. 8 and 9, the bare wire end 311 includes an adapter 314, which can be in the form of a sleeve or terminal. Through tight or interference fit and other mechanical assembly structures, the adapter 314 is firmly secured to the bare wire end 311. The adapter 314 and the bare wire end 311 are made of different metal materials. Therefore, when the coil 4 and the bare wire end 311 are made of different metal materials, using an adapter 314 made of the same metal material as the coil 4 to secure the bare wire end 311 allows for easy welding of the lead end 41 to the adapter 314.

While we have shown and described the embodiment in accordance with the present invention, it should be clear to those skilled in the art that further embodiments may be made without departing from the scope of the present invention.

What is claimed is:

1. A motor stator winding structure comprising:
a stator wire frame having a block connected to one side thereof, the block including a connecting portion extending therefrom and being perpendicular to the stator wire frame, the connecting portion having a first mating surface with a plurality of grooves, the first mating surface located opposite to the stator wire frame;
a connecting member having a second mating surface, the second mating surface of the connecting member includes a plurality of channels defined therethrough, a plurality of protrusions protruding from the second matching surface;
a wire group extending through the connecting member, the wire group having multiple wires, each wire having a bare wire end on one end, an encapsulation segment and an extension segment extending along the bare wire end, and
wherein the encapsulation segment is combined within the channel of the connecting member, and the bare wire end and the extension segment extend out of the connecting member respectively, the second mating surface is fixed with the first mating surface by securely engaging the protrusions with the grooves to connect the connecting member onto the stator wire frame.

2. The motor stator winding structure as defined in claim 1, wherein the second mating surface is fixed with the first mating surface by at least one of high-frequency fusion welding, light-curing adhesive bonding, and anaerobic adhesive (Thread-locking fluid) bonding.

3. The motor stator winding structure as claimed in claim 1, wherein the protrusions are dovetail protrusions, and the grooves are dovetail grooves.

4. The motor stator winding structure as claimed in claim 1, wherein the connecting portion includes a plurality of separators extending from a top surface thereof, each bare wire end of the wires extends outward from the connecting member in the same direction as the separators.

5. The motor stator winding structure as claimed in claim 1, wherein the connecting member is formed by injection molding or hot pressing to combine with the wire group.

6. The motor stator winding structure as claimed in claim 1, wherein the connecting member includes two clamps and each of the two clamps includes a plurality of slots, the wires are respectively placed in the slots, the two clamps fix and combine the wire group.

7. The motor stator winding structure as claimed in claim 1, wherein the bare wire end has an adapter.

8. A method for assembling a stator wire frame including a stator wire frame, a connecting member and a wire group, comprising:
a step S11: providing a mold, and an encapsulation segment of each of multiple wires of the wire group being placed inside the mold;
a step S12: extending a bare wire end and an extension segment of each wire outside the mold respectively;
a step S13: pouring material into the mold, cooling, and demolding to complete the connecting member;
a step S14: affixing a first mating surface of a connecting portion attached to the stator wire frame to a second mating surface of the connecting member;
a step S15: fixing the second mating surface onto the first mating surface by using a mating means;
a step S16: winding a plurality of wire coils around the stator wire frame;
a step S17: wrapping an output end of each of the wire coils around each of the bare wire ends, and
a step S18: welding and securing the respective output end and the bare wire end.

9. A method for assembling a stator wire frame including a stator wire frame, a connecting member and a wire group, comprising:
a step S21: providing a clamp with a plurality of slots defined through the clamp;
a step S22: placing an encapsulation segment of each of wires of the wire group into the respective slots of the clamp;
a step S23: extending a bare wire end and an extension segment of each of the wires outside the clamp respectively;
a step S24: fixing the clamp to complete the connecting member;
a step S25: affixing a first mating surface of a connecting portion attached to the stator wire frame to a second mating surface of the connecting member;
a step S26: fixing the second mating surface onto the first mating surface by using a mating means;
a step S27: winding a plurality of wire coils around the stator wire frame;
a step S28: wrapping an output end of each of the wire coils around each of the bare wire ends, and
a step S29: welding and securing the respective output end and the bare wire end.
